(19) United States
(12) Patent Application Publication
(10) Pub. No.: US 2018/0036626 A1
(43) Pub. Date: Feb. 8, 2018

(54) MODULAR DRIVE SYSTEM FOR SKATEBOARDS

(71) Applicant: Dash Electric, Inc., Sudbury, MA (US)

(72) Inventor: Ian Clifford Carlson, Boston, MA (US)

(21) Appl. No.: 15/226,302

(22) Filed: Aug. 2, 2016

(51) Int. Cl. A63C 17/12; B60K 7/00; A63C 17/01

(52) U.S. Cl. CPC A63C 17/12; A63C 17/015; B60K 7/0007; A63C 2203/12; B60Y 2200/91; B60Y 2400/112; B60K 2007/0092

(57) ABSTRACT

A modular motorized drive system for skateboards allows users to quickly and easily swap out electronics, battery packs, motors, and other components on their skateboards with replacement or upgraded components. Users can thereby keep their skateboards for long periods of time without the skateboards becoming outdated. The modular motorized drive system also allows users to easily convert non-motorized skateboards into motorized skateboards. The modular drive system can be mounted on most skateboards on the market using both the new and old school industry-standard truck mounting patterns.

### BACKGROUND

The present application relates generally to skateboards (including standard-length skateboards and longboards) and, more particularly, to a modular motorized drive system for skateboards.

A significant problem with current electric skateboards is that they cannot easily be upgraded or maintained by the user. Electric skateboards are typically sold as complete setups where the motor and electronics are permanently installed to the board. As electric vehicle technology improves, electric skateboard components like electronics and batteries can quickly become outdated. Users must generally purchase an entirely new electric skateboard to have the most up to date components. Battery packs also degrade over time and lose their charge capacity, requiring replacement. Users may also want to add a second battery pack to increase the distance they can travel without recharging the installed pack. Electric motors, which wear out over time and need to be replaced or upgraded, are also not typically replaceable by users. It would be desirable for users to have the ability to quickly and easily replace components of motorized skateboards.

The skateboard community is built around riders having a skateboard that fits their personality and riding style. It would be desirable for longboarders and other skateboarders to be able to quickly and easily convert their existing non-motorized skateboards to electrically powered skateboards using a motorized drive system retrofit kit.

### BRIEF SUMMARY OF THE DISCLOSURE

In accordance with one or more embodiments, a modular motorized drive system kit is disclosed for installation on a non-motorized skateboard. The kit includes at least one wheel equipped with a built in electric hub motor configured to replace a wheel of the non-motorized skateboard. The kit also includes a battery unit including a housing and one or more rechargeable batteries removably stored therein. The kit further includes a control unit including a housing and a motor controller removably stored therein. The housings of the control unit and/or the battery unit include a fastener for releasably connecting the housings to each other. The motor controller is electrically connectable with the one or more rechargeable batteries and the electric hub motor of the at least one wheel such that the motor controller can control power supplied by the one or more batteries to the electric hub motor. The kit also includes an attachment bracket for removably attaching the battery unit and the control unit to a deck of the skateboard.

In accordance with one or more embodiments, a motorized skateboard is disclosed having a modular drive system. The skateboard includes a deck having an upper side for supporting the rider and an opposite lower side. A front truck assembly supporting two front wheels and a rear truck assembly supporting two rear wheels is mounted on the opposite lower side of the deck, wherein at least one of the front and rear wheels is equipped with a built in electric hub motor. A battery unit includes a housing and one or more rechargeable batteries removably stored therein. A control unit includes a housing and a motor controller removably stored therein. The housings of the control unit and/or the battery unit include a fastener for releasably connecting the housings to each other. The motor controller is electrically connected with the one or more rechargeable batteries and the electric hub motor of the at least one wheel such that the motor controller can control power supplied by the one or more batteries to the electric hub motor. An attachment bracket removably attaches the battery unit and/or the control unit to the deck.

In accordance with one or more embodiments, a method is disclosed for retrofitting a conventional non-motorized skateboard with a modular motorized drive system. The skateboard includes a deck, a front truck assembly supporting two front wheels, and a rear truck assembly supporting two rear wheels. The method includes the steps of:
disconnecting mounting bolts connecting one of the truck assemblies the front truck assembly to the deck of the skateboard to separate the front truck assembly from the deck;
removing at least one of the front wheels from the front truck assembly or the rear wheels from the rear truck assembly and replacing the removed wheel with a wheel equipped with a built-in hub motor;
installing an assembly comprising a battery unit, a control unit, and an attachment bracket on a rear side of the deck by placing the attachment bracket between the deck and the front-truck assembly, aligning mounting holes on the attachment bracket with mounting holes in the deck and front the truck assembly, and using mounting bolts to secure the front truck assembly to the deck and the attachment bracket; and
electrically connecting each wheel equipped with a built-in hub motor to a motor controller in the control unit.

### BRIEF DESCRIPTION OF THE DRAWINGS

FIG. 1 is a bottom perspective view of an exemplary skateboard equipped with a modular drive system in accordance with one or more embodiments.

FIG. 2 is a side view of the exemplary skateboard of FIG. 1.

FIG. 3 is a bottom plan view of the front portion of the exemplary skateboard of FIG. 1.

FIG. 4 is a bottom perspective view of the exemplary skateboard of FIG. 1, showing the battery unit separated from the control unit of the modular drive system.

FIG. 5 is an exploded bottom perspective view of the modular drive system in accordance with one or more embodiments.

FIG. 6 is an exploded top view of the modular drive system of FIG. 5.

FIG. 7 is a perspective view of an exemplary truck in accordance with one or more embodiments.

FIG. 8 is a top view of the truck of FIG. 7.

FIG. 9 is a perspective view of an exemplary attachment bracket of the modular drive system in accordance with one or more embodiments.

FIG. 10 is a perspective view of an alternate exemplary attachment bracket of the modular drive system in accordance with one or more embodiments.

FIG. 11 is a perspective view of the attachment bracket of FIG. 10 having a control unit and a battery unit connected to the bracket in accordance with one or more embodiments.

FIG. 12 is a perspective view of yet another alternative attachment bracket having a control unit attached to a front portion of the bracket in accordance with one or more embodiments.

FIG. 13 is a perspective view of an exemplary wheel with a built-in hub motor of the modular drive system in accordance with one or more embodiments.

FIG. 14 is an exploded view of the wheel of FIG. 13.

FIG. 15 is a schematic block diagram illustrating components of an exemplary control unit of the modular drive system in accordance with one or more embodiments.

### DETAILED DESCRIPTION

Various embodiments disclosed herein are directed to a modular motorized drive system for skateboards, which allows users to quickly and easily swap out electronics, battery packs, motors, and other components on their skateboards with replacement or upgraded components. Users can thereby keep their skateboards for long periods of time without the skateboards becoming outdated. The modular motorized drive system also allows users to easily convert non-motorized skateboards into motorized skateboards. The modular drive system can be mounted on most skateboards on the market using both the new and old school industry-standard truck mounting patterns.

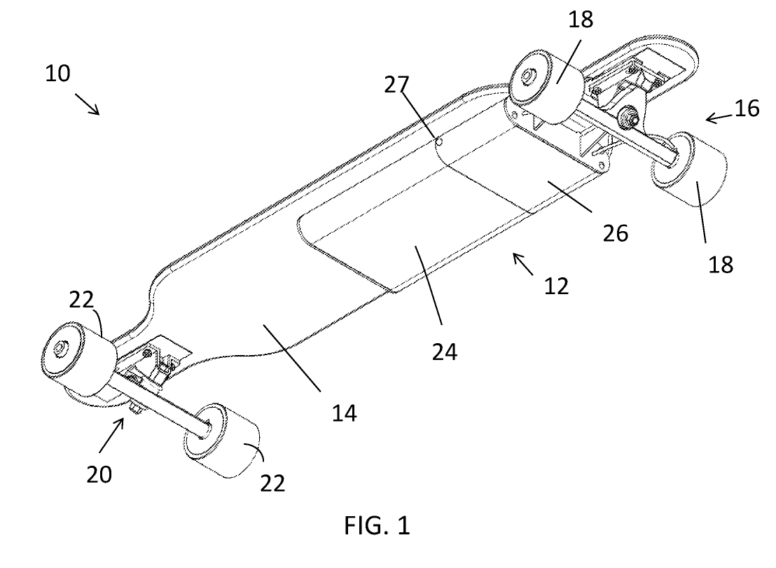

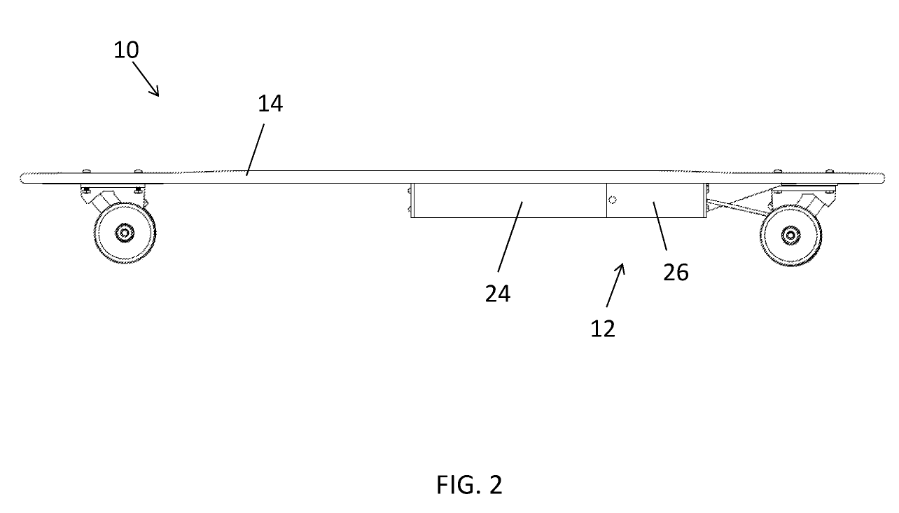

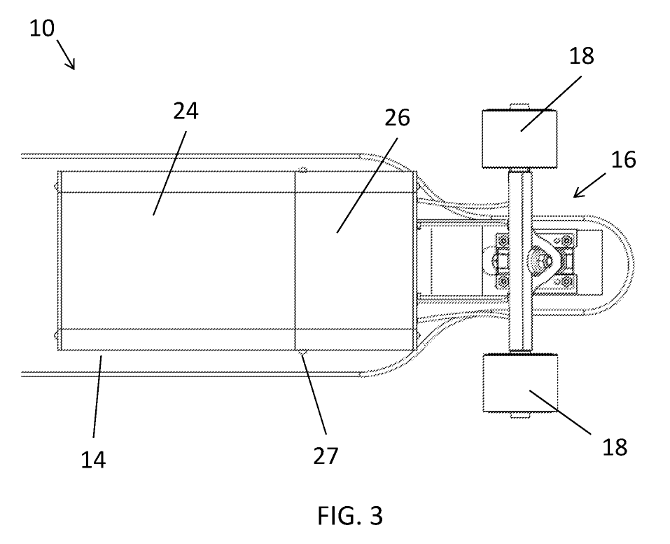

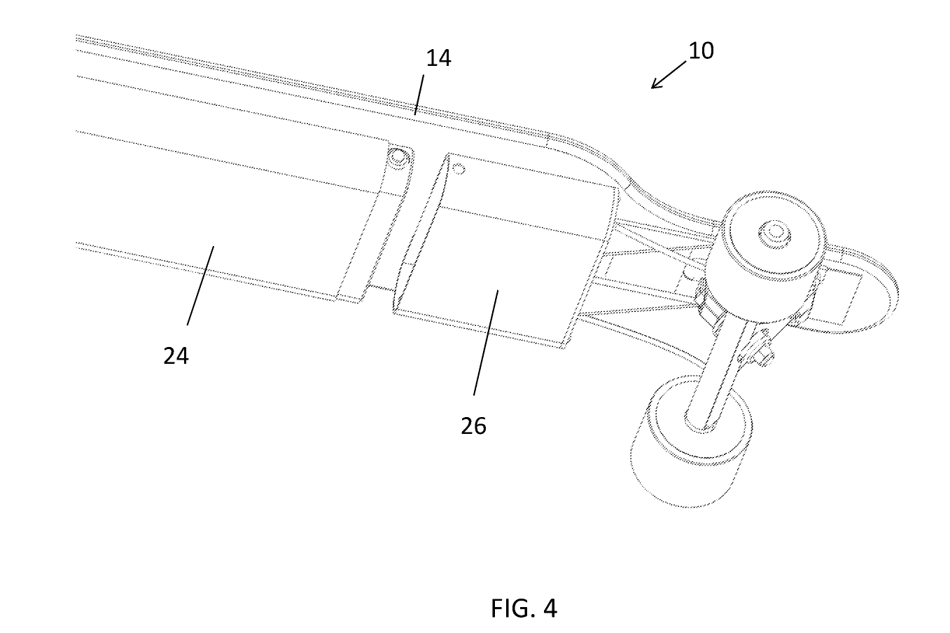

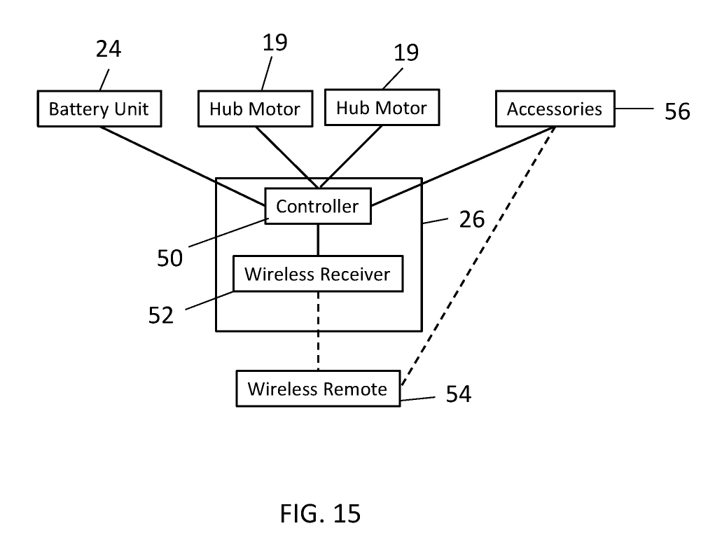

FIGS. 1-4 illustrate an exemplary skateboard 10 fitted with a modular motorized drive system 12 in accordance with one or more embodiments. The skateboard 10 includes a deck 14 having an upper side for supporting the rider. A front truck assembly 16 supporting two front wheels 18 and a rear truck assembly 20 supporting two rear wheels 22 are mounted on the opposite lower side of the deck 14. A battery unit 24 and a control unit 26 are also mounted on the lower side of the deck 14. The drive system 12 is controlled by the rider via a wireless remote control device 54 (shown in FIG. 15).

The battery unit 24 includes an outer housing, which holds one or more rechargeable batteries or battery packs therein. The battery unit 24 can be detached and replaced, as needed. The housing includes a battery connector for making electrical contact with battery terminals.

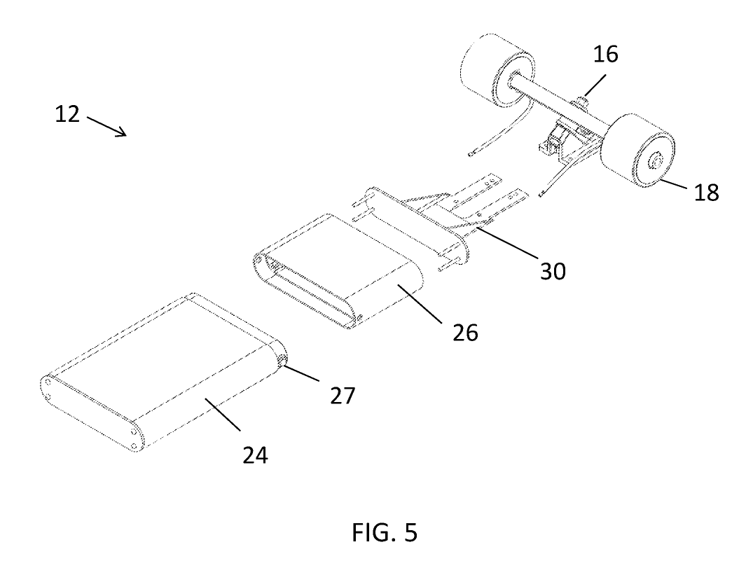

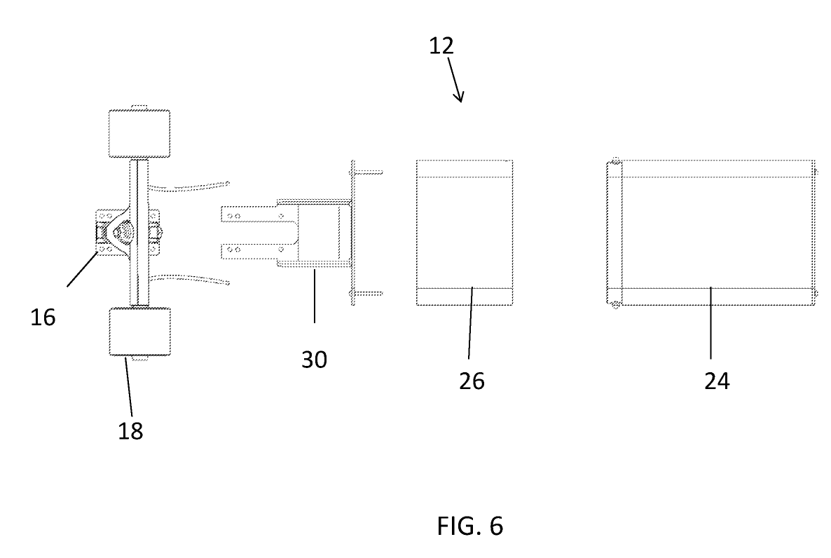

The housing of the battery unit 24 is attached to the housing of the control unit 26 in a side-by-side arrangement by means of releasable fasteners 27. FIGS. 1-5 show exemplary quick release fasteners 27, each comprising a resilient pressable protruding button on opposite sides of the housing of the battery unit 24, which can engage corresponding openings in the housing of the control unit 26. The buttons can be pressed to disengage them from the openings, allowing the housings to be separated.

Various types of battery packs may be used in the battery unit 24. By way of non-limiting example, A123 26650 LiFePo4 cells, a li-ion chemistry battery, may be used. Other sizes and form factors of batteries may also be used such as, e.g., an 18650 size battery, prismatic pouch cells, etc.

The control unit 26 includes an outer housing, which holds a circuit board containing various electronic components, including a motor controller, for controlling operation of the drive system 12, as will be described further below in connection with FIG. 15. In one exemplary embodiment, the housing includes slots on opposite sides in the interior of the housing for slidingly receiving the circuit board. The circuit board can thereby be easily inserted or removed from the housing of the control unit 26.

When the control unit 26 and the battery unit 24 are assembled, there is an electrical connection between the motor controller and the batteries or battery packs. In accordance with one or more embodiments, the skateboard has a four wheel drive system whereby all four wheels are motorized. In this embodiment, skateboard can include two separate control systems, one for each of the front and rear sets of wheels. In this embodiment, the two control systems communicate with each other through wired or wireless links. In one or more embodiments, the electrical connection that connects the positive and negative terminals of the battery pack to the positive and negative terminals of the receiving end of the first control system can also be data terminals to carry a signal from the first control unit through the battery pack to the second control unit when used in the four wheel drive system/two control unit configuration. The signal is used to carry the control input from the user to the motor controllers. In one or more alternate embodiments, the system includes separate wired connections for data and power.

The housing of the battery unit 24 and the housing of the control unit 26 can comprise a variety of materials including, e.g., molded plastic, carbon fiber, and aluminum or other metals (or combinations thereof). The housing of the battery unit 24 and the housing of the control unit 26 provide protection for their respective components from impacts and the environment (including exposure to liquids).

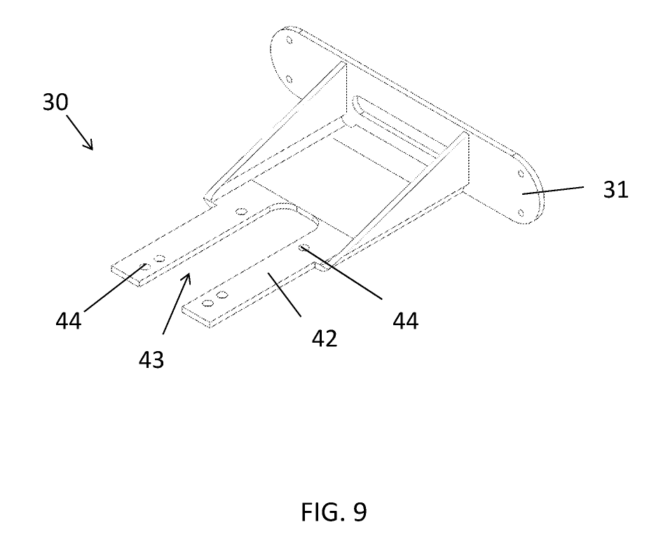

An attachment bracket 30 shown in detail in FIG. 9 removably attaches the housing of the control unit 26 to the deck 14. The attachment bracket 30 includes a plate 31 acting as a cover for enclosing the front end of the housing of the control unit 26. The plate is connected by screws, bolts, or other fasteners to the housing of the control unit 26. The attachment bracket 30 also includes a tongue member 42 extending from the plate. The tongue member 42 includes a set of mounting holes 44 for attachment to the deck 14 as will be described below. The attachment bracket 30 can comprise a variety of materials including, e.g., molded plastic, carbon fiber, and aluminum or other metals (or combinations thereof).

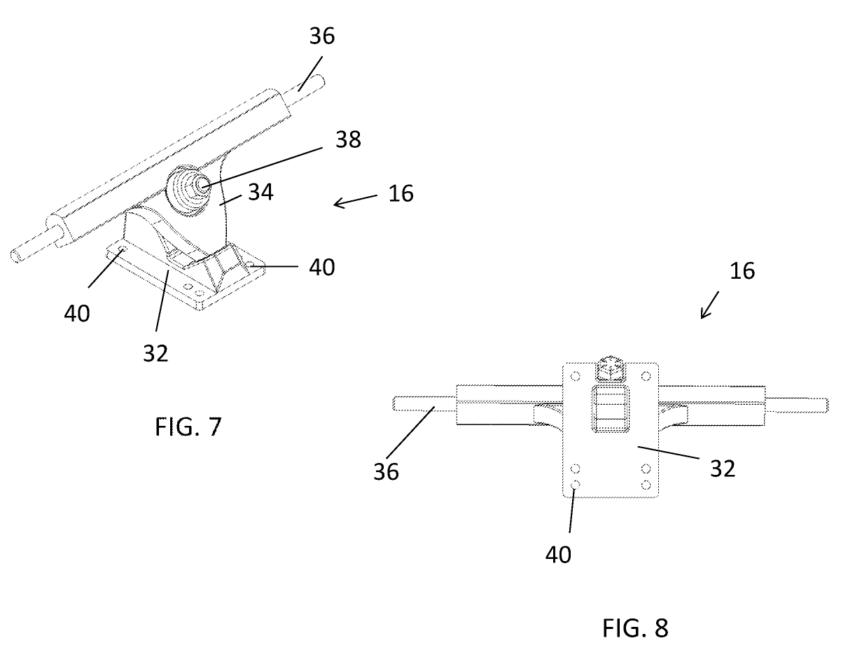

FIGS. 7 and 8 illustrate one example of a conventional commercially available front truck assembly 16 that can be used with the drive system 12 in accordance with one or more embodiments. (The same truck assembly can be used as the rear truck assembly 20. The orientation of the rear truck assembly 20 may be reversed (i.e., backward facing) depending on whether or not the skateboard is a longboard.) The truck assembly 16 includes a base plate 32, which is attached to the deck 14, a hanger 34 pivotally engaging the base plate 32 at a pivot end, axle 36 extending laterally from the hanger 34 on which the wheels 18 are rotatably mounted, and a kingpin 38 holding the hanger 34 in place. The kingpin 38 may be tightened or loosened to adjust the turning responsiveness of the skateboard 10.

The truck assembly base plate 32 includes a set of mounting holes 40 for mounting the truck assembly to the deck 14. There are typically two standard hole patterns: new school and old school, both utilizing four holes. Six holes are shown in the base plate 32. Of these six holes, a different set of four holes is used depending on whether the mounting is new school or old school.

As shown in FIG. 9, tongue member 42 of the attachment bracket 30 includes a set of six mounting holes 44 that correspond to and accommodate the hole patterns of both new school and old school truck assemblies. When installed, the tongue member 42 is between the truck assembly base plate 32 and the bottom of the deck 14 such that the mounting holes of the tongue member 42 and the base plate 32 are aligned with corresponding mounting holes in the deck 14. The deck 14 is attached to the tongue member 42 and the base plate 32 with bolts extending through the respective mounting holes, and secured by nuts underneath the base plate 32. The tongue member 42 preferably has six holes to accommodate both old school and new school standard hole patterns.

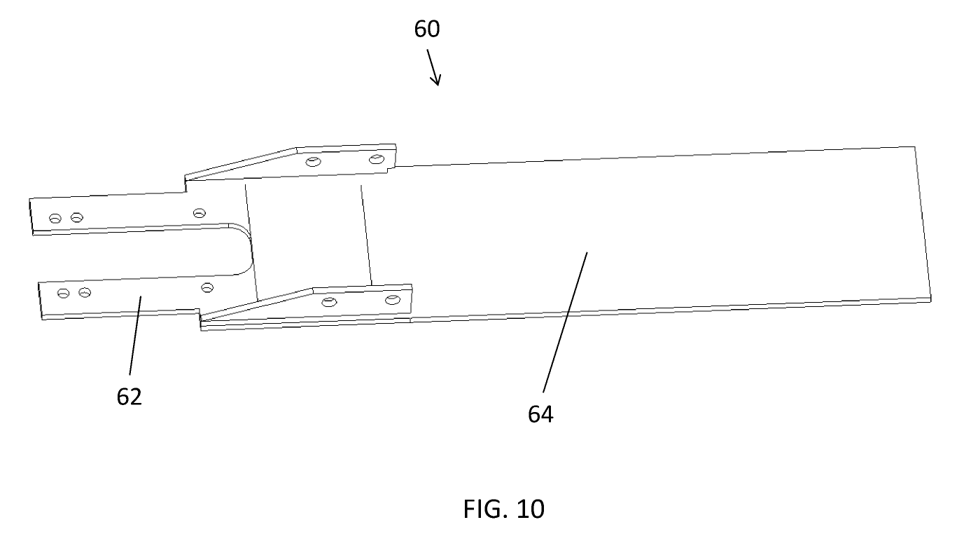

The tongue member 42 has a cutout 43 in the middle of it to allow for the option of “drop through” mounting of the trucks where the top plate of the truck is mounted on the top side of the board. This mounting style lowers the board for a lower center of gravity. FIG. 10 illustrates an alternative attachment bracket 60 in accordance with one or more embodiments. The bracket 60 includes a tongue member 62 and an elongated plate 64, on which a control unit 66 and battery unit 68 may be mounted.

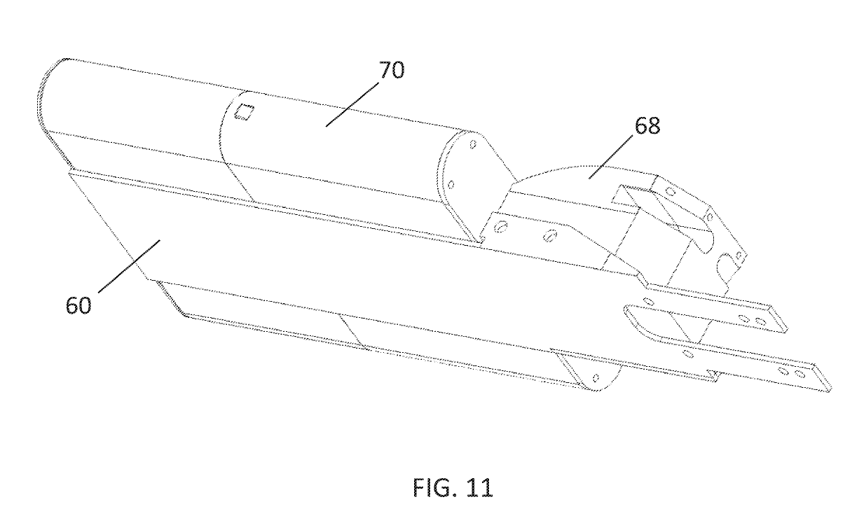

FIG. 11 illustrates yet another attachment bracket 66, on which a control unit 68 and battery unit 70 may be mounted.

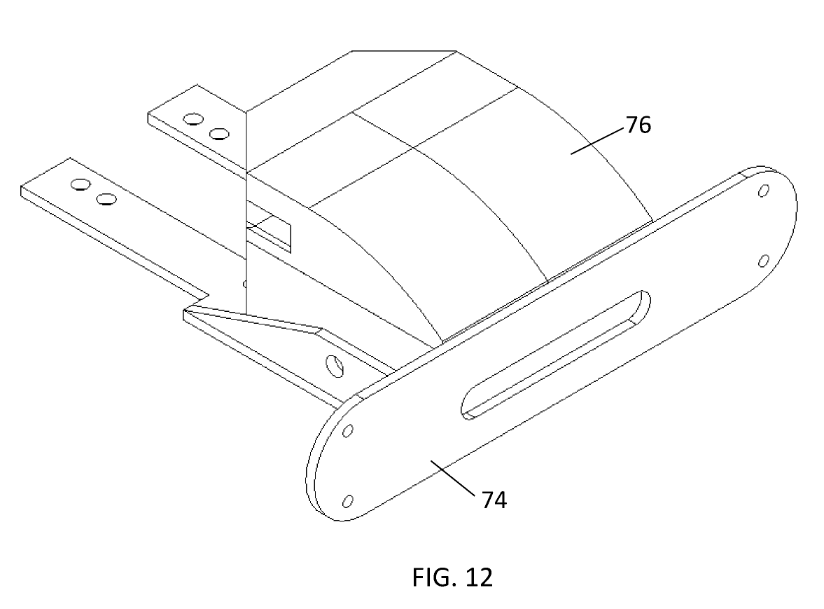

FIG. 12 illustrates another exemplary attachment plate 74, on which a control unit 76 may be mounted.

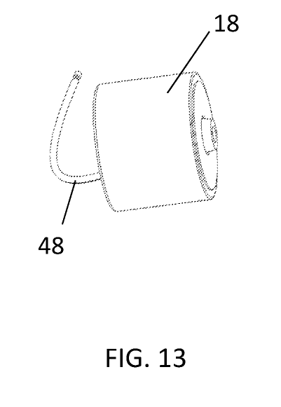

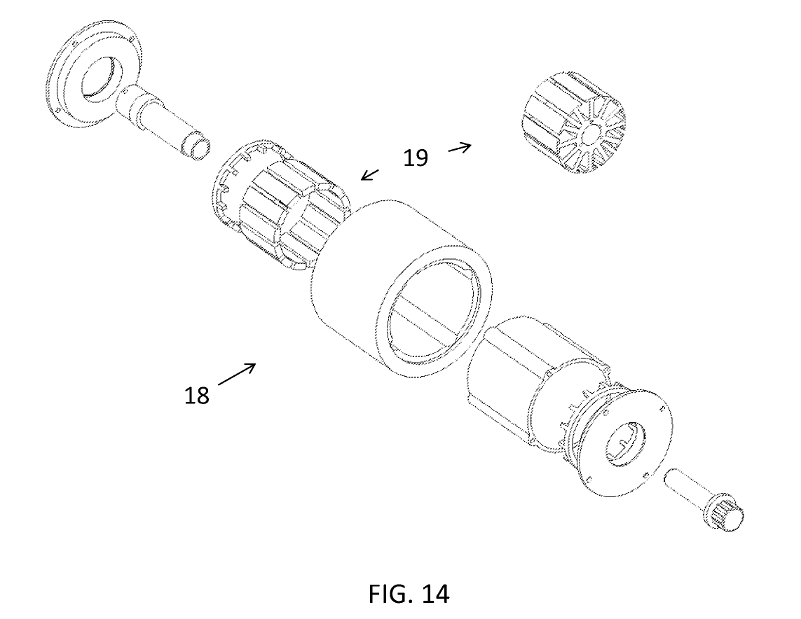

FIGS. 13 and 14 illustrate an exemplary wheel 18 of the skateboard 10, which can be mounted on the axle 36 of the front truck assembly 16. The wheel 18 includes an electric hub motor 19 incorporated therein, which directly drives the wheel 18. The electric hub motor 19 is electrically connected by a cable 48 to the control unit 26. The control unit 26 controls supply of electrical power from the battery unit 24 to the hub motor 19 in each front wheel 18.

One exemplary process of replacing standard wheel with a hub motor wheel is as follows. The hub motor is slid over the longboard truck axle. Then a female threaded bolt is screwed over the threads on the longboard axle. The bolt is tightened to “sandwich” the motor between the truck and the bolt. Secondary securement can be provided by a set screw on the motor that tightens down on the longboard axle to resist the motor loosening when riding.

In the examples illustrated in the drawings, the front two wheels 18 of the skateboard 10 include electric hub motors 19 incorporated therein. In accordance with one or more alternate embodiments all four wheels of the skateboard 10 include hub motors, which are also controlled by the control unit 26.

As shown in FIG. 15, the control unit 26 includes a controller 50, which controls flow of current from the battery unit 24 to the hub motors 19 in the front wheels 18. The controller 50 is connected to a wireless receiver 52, which wirelessly receives operating signals from a wireless remote 54 operated by the skateboard user. The controller 50 controls the speed of the hub motors 19 by varying the power supplied to the hub motors 19 by the battery unit 24.

The controller 50 can comprise a microcontroller, microprocessor, application-specific integrated circuit (ASIC), field programmable gate arrays (FPGA), or any general-purpose or special-purpose circuitry that can be programmed or configured to perform the functions described herein.

In accordance with one or more embodiments, one or more accessories 56 may also be controlled by the controller. Such accessories 56 can include, e.g., lights or audio speakers built into the skateboard 10. The accessories 56 may also be directly controlled by the remote control device.

A conventional non-motorized skateboards can be retrofitted with the modular motorized drive system 12 as follows. The mounting bolts connecting the front truck assembly to the deck of the skateboard are removed to separate the truck assembly from the deck. The front wheels on the truck assembly are removed and replaced by wheels 18 equipped with built-in hub motors 19. An assembly comprising a battery unit 24, a control unit 26, and an attachment bracket is placed on the rear side of the deck such that the mounting holes on the attachment bracket are aligned with mounting holes in the deck. The truck is placed on the attachment bracket such that the mounting holes on the truck are aligned with the mounting holes on the attachment bracket and the deck. Mounting bolts are then used to attach the deck to the attachment bracket 30 and the front truck assembly. The cables 48 connected to the hub motors 19 are then attached to the control unit 26.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. Accordingly, the foregoing description and attached drawings are by way of example only, and are not intended to be limiting.

What is claimed is:

1. A modular motorized drive system kit for installation on a non-motorized skateboard, comprising:
at least one wheel equipped with a built in electric hub motor configured to replace a wheel of the non-motorized skateboard;
a battery unit including an impact and liquid resistant housing and one or more rechargeable batteries stored therein;
a control unit including an impact and liquid resistant housing and a motor controller removably stored therein, said housings of the control unit and/or the battery unit including a fastener for releasably connecting the housings to each other in a side-by-side arrangement laterally along a deck of the skateboard, said motor controller being electrically connectable with said one or more rechargeable batteries and the electric hub motor of the at least one wheel such that said motor controller can control power supplied by the one or more batteries to the electric hub motor; and
an attachment bracket for removably attaching the battery unit and the control unit to the deck of the skateboard.

2. The modular motorized drive system kit of claim 1, further comprising a remote control device communicating with the motor controller, said remote control device being operable by a rider to control operation of the drive system.

3. The modular motorized drive system kit of claim 2, wherein said control unit includes a wireless receiver connected to said motor controller, said wireless receiver configured to communicate wirelessly with said remote control device.

4. The modular motorized drive system kit of claim 1, wherein the skateboard includes a front truck assembly and a rear truck assembly, each including a base plate having a plurality of mounting holes corresponding to mounting holes in the deck, and wherein the attachment bracket includes a tongue member having a plurality of mounting holes corresponding to mounting holes in the deck and the base plate of the front truck assembly and the rear truck assembly, said tongue member being configured to be positioned between and secured to the deck and the base plate of the front or rear truck assembly using mounting bolts extending through said mounting holes in said deck and the base plate of the front or rear truck assembly.

5. The modular motorized drive system kit of claim 1, wherein the at least one wheel comprises at least one front wheel equipped with a built-in electric hub motor and at least one rear wheel equipped with a built-in electric hub motor, and wherein the motorized drive system kit includes an additional control unit, each control unit being configured for controlling operation of a different one of the at least one front wheel and the at least one rear wheel.

6. A motorized skateboard having a modular drive system, comprising:
a deck having an upper side for supporting the rider and an opposite lower side;
a front truck assembly supporting two front wheels and a rear truck assembly supporting two rear wheels mounted on the opposite lower side of the deck, wherein at least one of said front and rear wheels is equipped with a built-in electric hub motor;
a battery unit including an impact and liquid resistant housing and one or more rechargeable batteries stored therein;
a control unit including an impact and liquid resistant housing and a motor controller removably stored therein, said housings of the control unit and/or the battery unit including a fastener for releasably connecting the housings to each other in a side-by-side arrangement laterally along the deck, said motor controller being electrically connected with said one or more rechargeable batteries and the electric hub motor of the at least one wheel such that said motor controller can control power supplied by the one or more batteries to the electric hub motor; and
an attachment bracket for removably attaching the battery unit and/or the control unit to the deck.

7. The motorized skateboard of claim 6, further comprising a remote control device communicating with the motor controller, said remote control device being operable by a rider to control operation of the drive system.

8. The motorized skateboard of claim 6, wherein said control unit includes a wireless receiver connected to said motor controller, said wireless receiver configured to communicate wirelessly with said remote control device.

9. The motorized skateboard of claim 6, wherein the front truck assembly and the rear truck assembly each includes a base plate having a plurality of mounting holes corresponding to mounting holes in the deck, and wherein the attachment bracket includes a tongue member having a plurality of mounting holes corresponding mounting holes in the deck and the base plate of the front truck assembly, said tongue member being configured to be positioned between and secured to the deck and the base plate of the front truck assembly or rear truck assembly using mounting bolts extending through said mounting holes in said deck and the base plate of the front truck assembly or the rear truck assembly.

10. A method of retrofitting a conventional non-motorized skateboard with a modular motorized drive system, said skateboard having a deck, a front truck assembly supporting two front wheels, and a rear truck assembly supporting two rear wheels, the method comprising the steps of:
disconnecting mounting bolts connecting one of the truck assemblies to the deck of the skateboard to separate the truck assembly from the deck;
removing at least one of the wheels from the truck assembly and replacing the removed wheel with a wheel equipped with a built-in hub motor;
installing an assembly comprising a battery unit, a control unit, and an attachment bracket on a rear side of the deck such that the control unit and the battery unit are in a side-by-side arrangement laterally along the deck by placing the attachment bracket between the deck and the truck assembly, aligning mounting holes on the attachment bracket with mounting holes in the deck and the truck assembly, and using mounting bolts to secure the truck assembly to the deck and the attachment bracket, wherein the battery unit includes an impact and liquid resistant housing and one or more rechargeable batteries stored therein, and the control unit includes an impact and liquid resistant housing and a motor controller removably stored therein; and
electrically connecting each wheel equipped with a built-in hub motor to the motor controller in the control unit.

11. The method of claim 10, further comprising replacing at least one front wheel and at least one rear wheel with a wheel equipped with a built-in hub motor.
